(19) United States
(12) Patent Application Publication
(10) Pub. No.: US 2016/0116021 A1
(43) Pub. Date: Apr. 28, 2016

(54) VARIABLE INERTIA FLYWHEEL

(71) Applicant: Caterpillar Inc., Peoria, IL (US)

(72) Inventor: Evan E. Jacobson, Edwards, IL (US)

(73) Assignee: Caterpillar Inc., Peoria, IL (US)

(21) Appl. No.: 14/981,925

(22) Filed: Dec. 29, 2015

(51) Int. Cl. F16F 15/31

(52) U.S. Cl. CPC F16F 15/31

(57) ABSTRACT

A flywheel including a rim having a circular shape, a first hub disposed coaxially within the rim, and at least two spokes having a first end coupled to the rim, and a second end coupled to the first hub. A second hub disposed coaxially with the rim, and having at least one guiding member. The at least one guiding member having a slot. The flywheel includes at least two assemblies corresponding to the at least two spokes, such that one of the at least two assemblies is coupled to one of the at least two spokes. A first weight having at least one protruding member. A spring member disposed adjacent to the first weight, and a support member disposed adjacent to the spring member. A weight assembly including at least one second weight and a mount member. The flywheel including an actuator coupled to the second hub.

### TECHNICAL FIELD

The present disclosure relates to a flywheel, and more specifically, to the flywheel including weights.

### BACKGROUND

A flywheel is used for storage of energy in variety of machines such as, but not limited to vehicles. The flywheel can be used at different locations in a vehicle for receiving or supplying energy in a variety of scenarios. As generally known in the art, a flywheel is coupled with a crankshaft of an internal combustion engine. Energy is supplied to the flywheel during a power stroke of an engine through the crankshaft, and energy is received by the crankshaft from the flywheel during the remaining strokes of the engine. This arrangement ensures that a more constant angular speed of the crankshaft is maintained during different strokes of an internal combustion engine and a more constant torque is provided to a drive assembly of the vehicle.

Apart from the aforementioned, a flywheel can also be placed remotely from the crankshaft of an engine, and connected through gears to the drive shaft of the vehicle for storing and releasing of energy. In such a flywheel, it is required that the speed of the flywheel should match the speed of the gears attached to the drive shaft during coupling. Typically, an additional assembly is required to match the speed of the flywheel to the speed of the gears. This additional assembly makes the overall system more bulky and energy consuming. Another technique to match the speed of the flywheel is to use a flywheel which is able to vary its inertia. Such flywheels can regulate their speed without the need of any additional transmission assemblies. These flywheels include a mechanism to vary the distance of additional weights from the centre of the flywheel to change the inertia. However, such flywheels are not able to store enough energy due to instability of additional weights at high angular velocity of the flywheel. Hence, an improved flywheel is required that eliminates the need for an additional transmission assembly for varying its speed and also is stable at high angular velocities.

United States Publication Number 7044022 discloses a variable inertia flywheel apparatus which is connected to a crankshaft of an engine. It describes that a flywheel having variable inertia, a first and a second guide grooves respectively formed at a body of the flywheel and a rotatable member. A movable weight is disposed at the overlapping position, and the rotatable member rotates relatively to the body by hydraulic pressure. However, this reference does not disclose employing the flywheel remotely from the crankshaft for storing energy and any method for stabilizing the flywheel at high angular velocities. Hence, an improved flywheel structure is required that balances the forces generated by additional weights in a variable flywheel.

### SUMMARY OF THE INVENTION

In one aspect of the present disclosure, a flywheel is provided. The flywheel including a rim having a circular shape, a first hub disposed coaxially within the rim, and elongated along a first axis of the rim, and at least two spokes. Each of the at least two spokes having a first end coupled to the rim, and a second end coupled to the first hub. Further, the flywheel includes a second hub disposed coaxially with the rim, and adapted to slide on an outer surface of the first hub along the first axis of the rim. The second hub has at least one guiding member. The at least one guiding member including a slot. The flywheel includes at least two assemblies corresponding to the at least two spokes, such that one of the at least two assemblies is coupled to one of the at least two spokes. Each of the at least two assemblies including a first weight disposed adjacent to the first hub, and disposed coaxially with the one of the at least two spokes. The first weight is adapted to slide along a length of the one of the at least two spokes, and having at least one protruding member. The at least one protruding member is adapted to slide along the slot of the at least one guiding member. A spring member is disposed adjacent to the first weight along a radial direction, and the spring member is disposed coaxially with the first weight. The spring member is adapted to apply a spring force to the first weight to oppose the sliding of the first weight along the length of the one of the at least two spokes in the radial direction. A support member is disposed adjacent to the spring member along the radial direction, and the support member is disposed coaxially with the spring member. The support member is adapted to slide along the length of the one of the at least two spokes. A weight assembly including at least one second weight which is disposed adjacent to the support member along the radial direction. The at least one second weight having a cam shape, and is adapted to rotate about a second axis of the at least one second weight. The at least one second weight is adapted to compress the spring member above a predetermined angular velocity of the flywheel. The weight assembly including a mount member which is disposed coaxially with the support member, and is coupled to the at least one second weight. The mount member is adapted to slide along the length of the one of the at least two spokes. An actuator is coupled to the second hub, and is adapted to move the second hub along the first axis of the rim.

Other features and aspects of this disclosure will be apparent from the following description and the accompanying drawings.

### BRIEF DESCRIPTION OF THE DRAWINGS

FIG. 1 is a schematic diagram of a vehicle with a flywheel, in accordance with an embodiment of the present disclosure;

FIG. 2 is a three dimensional perspective view of the flywheel, in accordance with the embodiment of the present disclosure;

FIG. 3A is a front view of a section of the flywheel in accordance with the embodiment of the present disclosure;

FIG. 3B is a side sectional view of the of FIG. 3A taken along the line 1-1′ in accordance with the embodiment of the present disclosure;

FIG. 4 is a front view of the flywheel at a low speed, in accordance with the embodiment of the present disclosure; and

FIG. 5 is a front view of the flywheel at a high speed, in accordance with the embodiment of the present disclosure.

### DETAILED DESCRIPTION

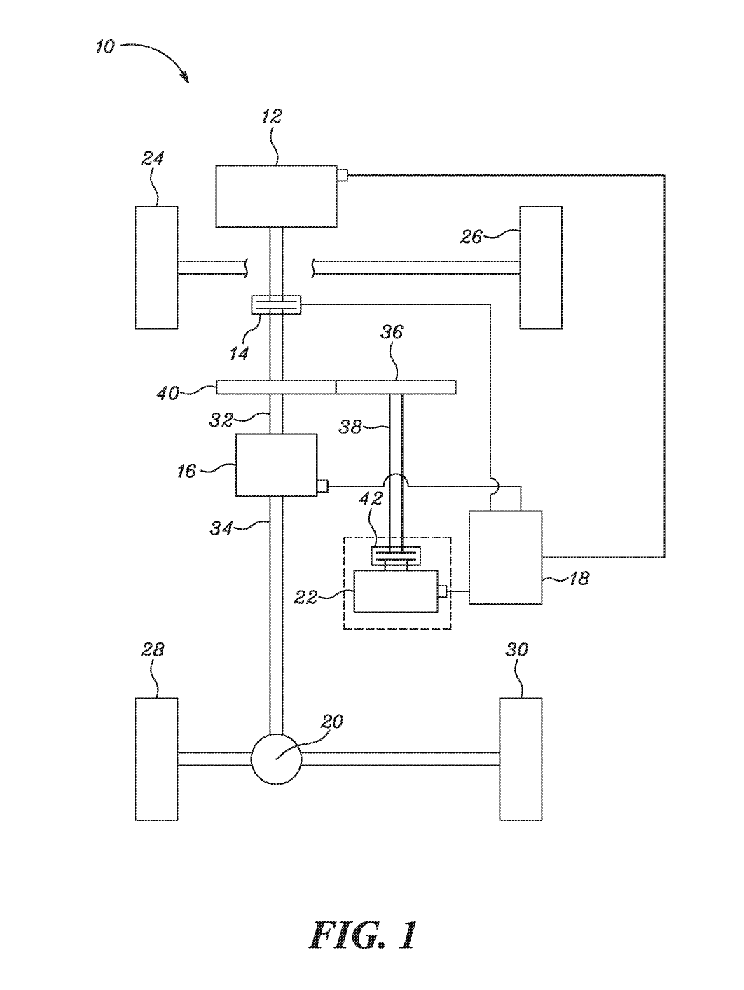

Referring to FIG. 1, a powertrain 10 includes an engine 12, a first clutch 14, a transmission module 16, a controller 18, a differential 20, and a flywheel 22 among other components. The powertrain 10 of a vehicle is adapted to couple the engine 12 that transmits power to wheels 24, 26, 28, 30. The wheels 24, 26, 28, 30 need power to drive the vehicle. The transmission module 16 is adapted to provide controlled application of power to the wheels 24, 26, 28, 30. It will be apparent to one skilled in the art that the powertrain 10 excluding the engine 12, the transmission module 16, and the controller 18 is also known as a driveline or a drivetrain without departing from the meaning and scope of the disclosure. According to an embodiment, the drivetrain may be a front-wheel drive, a rear-wheel drive or an all-wheel drive. The engine 12 is coupled to the differential 20 through the first clutch 14, a first drive shaft 32, the transmission module 16 and a second drive shaft 34.

The flywheel 22 is connected to a first gear 36 through a shaft 38. The first gear 36 is further coupled to a second gear 40. In an embodiment, the first gear 36 and the second gear 40 have a fixed gear ratio. The second gear 40 is coupled to the first drive shaft 32. The controller 18 is coupled to the engine 12, the first clutch 14, the transmission module 16 and the flywheel 22. The controller 18 is adapted to control electrical systems or subsystems of the vehicle such as, but not limited to, the first clutch 14. A second clutch 42 is adapted to couple or decouple the flywheel 22 to the first gear 36. When the vehicle moves and the flywheel 22 is coupled to the first gear 36 through the second clutch 42, the kinetic energy of the vehicle is stored or recovered from the flywheel 22, depending on a speed of the flywheel 22 with respect to speed of the first gear 36. The flywheel 22 is adapted to receive the kinetic energy from the first gear 36 of the powertrain 10, when the speed of the first gear 36 is greater than the speed of the flywheel 22. The flywheel 22 is adapted to transfer the kinetic energy to the first gear 36, when the speed of the first gear 36 is less than the speed of the flywheel 22. The flywheel 22 is adapted to receive the kinetic energy from the first gear 36, when the speed of the first gear 36 greater than the speed of the flywheel 22. The flywheel 22 is decoupled from the first gear 36 by the second clutch 42, when the flywheel 22 is not required.

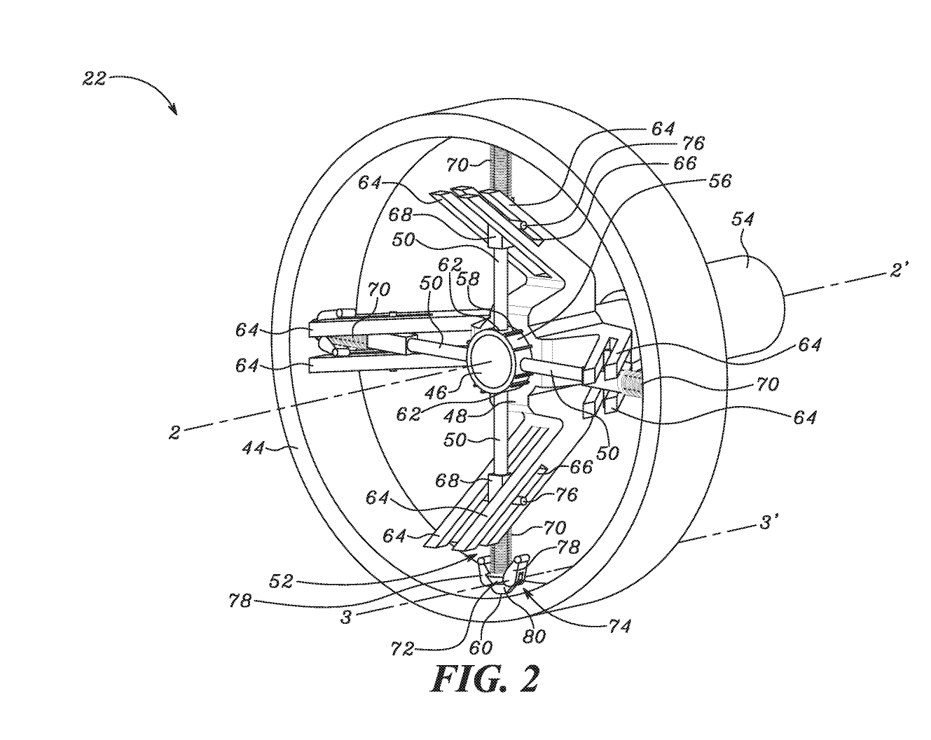

Referring to FIG. 2, the flywheel 22 includes a rim 44 encompassing a first hub 46, a second hub 48, at least two spokes 50, at least two assemblies 52 corresponding to each of the at least two spokes 50, and an actuator 54. In an embodiment, the flywheel 22 has a design that includes at least two spokes 50 for operation. Those skilled in the art will appreciate that the flywheel 22 may also use any number of spokes 50 for proper operation of the flywheel 22 without departing from the meaning and scope of the disclosure. In the exemplary embodiment shown in FIG. 2, the flywheel 22 has four spokes 50, and four assemblies 52 corresponding to the four spokes 50. The rim 44 has a circular shape of a predetermined diameter. The first hub 46 is disposed coaxially within the rim 44 and elongated along a first axis 2-2′of the rim 44. An outer surface 56 of the first hub 46 includes a number of splines 58. The spoke 50 has a first end 60 coupled to the rim 44 and a second end 62 coupled to the first hub 46. The second hub 48 is aligned coaxially with the rim 44. The second hub 48 is adapted to slide on the splines 58. The second hub 48 has at least one guiding member 64. The second hub 48 includes eight guiding members 64. The guiding member 64 has a slot 66. The slot 66 may have other shapes such as, but not limited to, rectangular shape, elliptical, curved edges, etc.

The assembly 52 includes a first weight 68, a spring member 70, a support member 72 and a weight assembly 74. The first weight 68 is disposed adjacent to the first hub 46 in a radial direction away from the first axis 2-2′ and aligned coaxially with the spoke 50. The first weight 68 is adapted to slide along a length of the spoke 50. The first weight 68 includes at least one protruding member 76 on each side of the first weight 68. In an embodiment, the first weight 68 includes two protruding members 76. The protruding member 76 slides along the slot 66 to enable movement of the first weight 68. The first weight 68 has a predetermined weight. The spring member 70 is aligned adjacent to the first weight 68 in a radial direction away from the first axis 2-2′ of the rim 44. The spring member 70 is also aligned coaxially with the first weight 68. The spring member 70 is a compression spring of a high spring rate. The support member 72 is disposed adjacent to the spring member 70 in the radial direction away from the first axis 2-2′ of the rim 44 and aligned coaxially with the spring member 70. The support member 72 is adapted to slide along the length of the spoke 50.

The weight assembly 74 includes at least one second weight 78 and a mount member 80. The second weight 78 is disposed adjacent to the support member 72 in a radial direction away from the first axis 2-2′ of the rim 44. The second weight 78 has a cam shape and a predetermined weight. The second weight 78 is adapted to rotate about a second axis 3-3′. The mount member 80 is aligned coaxially with the support member 72 and is adapted to slide along the length of the spoke 50. The second weight 78 is coupled via the mount member 80.

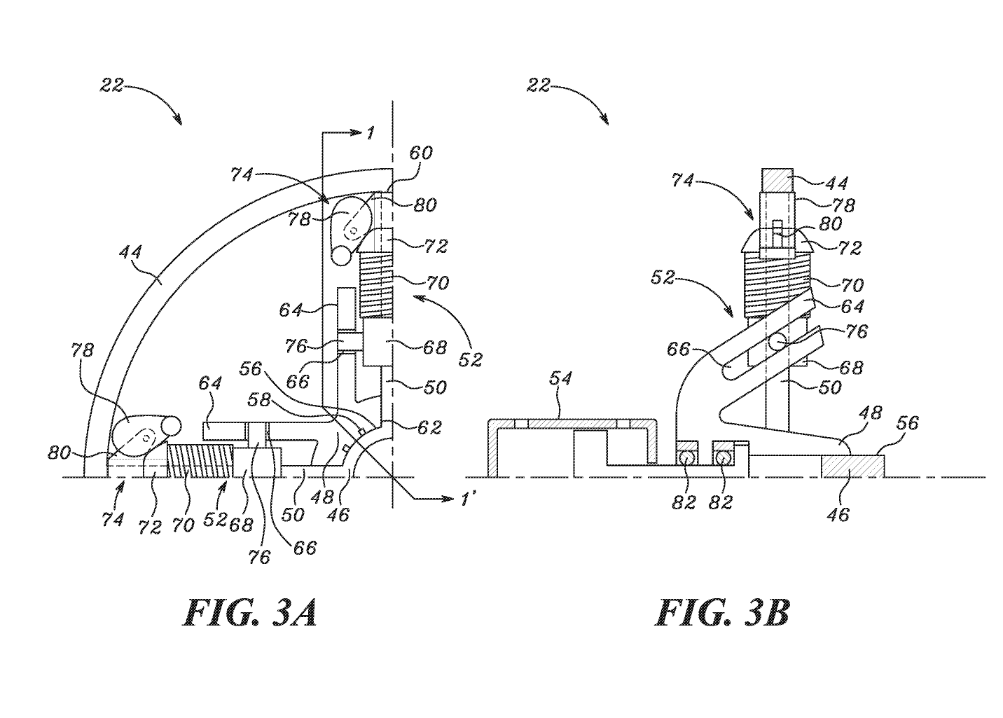

Referring to FIG. 3A and FIG. 3B, the actuator 54 of the flywheel 22 is coupled to the second hub 48 through bearings 82. The actuator 54 is adapted to move the second hub 48 along the first axis 2-2′ of the rim 44. As the second hub 48 moves along the first axis 2-2′, the guiding member 64 also moves along the first axis 2-2′. Due to the motion of the guiding member 64 along the axis 2-2′, 2′, the protruding member 76 adapted to slide along the slot 66 to move in the radial direction of the rim 44, leading to the motion of the first weight 68 along the length of the spoke 50. Since the position of the first weight 68 varies along the radial direction of the rim 44, the inertia of the flywheel 22 also varies. When the first weight 68 moves towards the rim 44, the inertia of the flywheel 22 increases and when the first weight 68 moves away from the rim 44, the inertia of the flywheel 22 decreases.

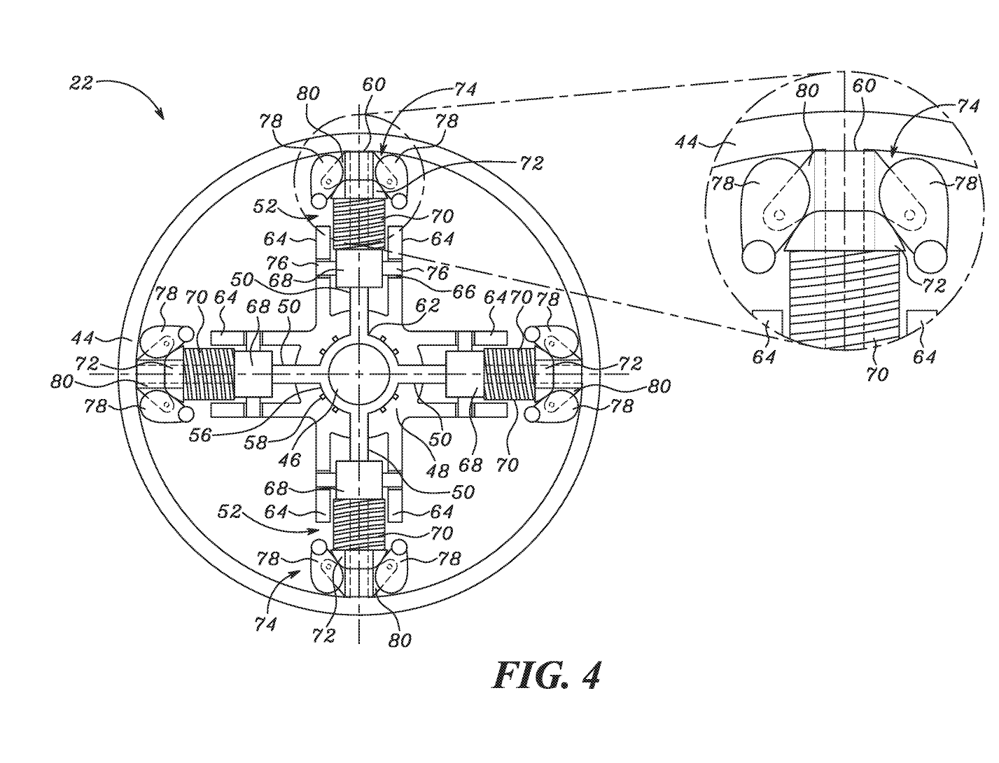

Referring to FIG. 4, when the flywheel 22 rotates at a lower rotational speed, internal stresses are generated in the first weight 68. The internal stresses (also called position stresses) are generated along the radial direction away from the first axis 2-2′ of the rim 44. The internal stresses are counterbalanced by the spring member 70 that applies a spring force along the radial direction towards the first axis 2-2′ of the rim 44 to oppose the sliding of the first weight 68. During lower rotational speed of the flywheel 22, the weight assembly 74 does not play any role to counterbalance the internal stresses. The second weight 78 of the weight assembly 74 remains in its normal position (also called home position) and is not adapted to push the support member 72 along the radial direction.

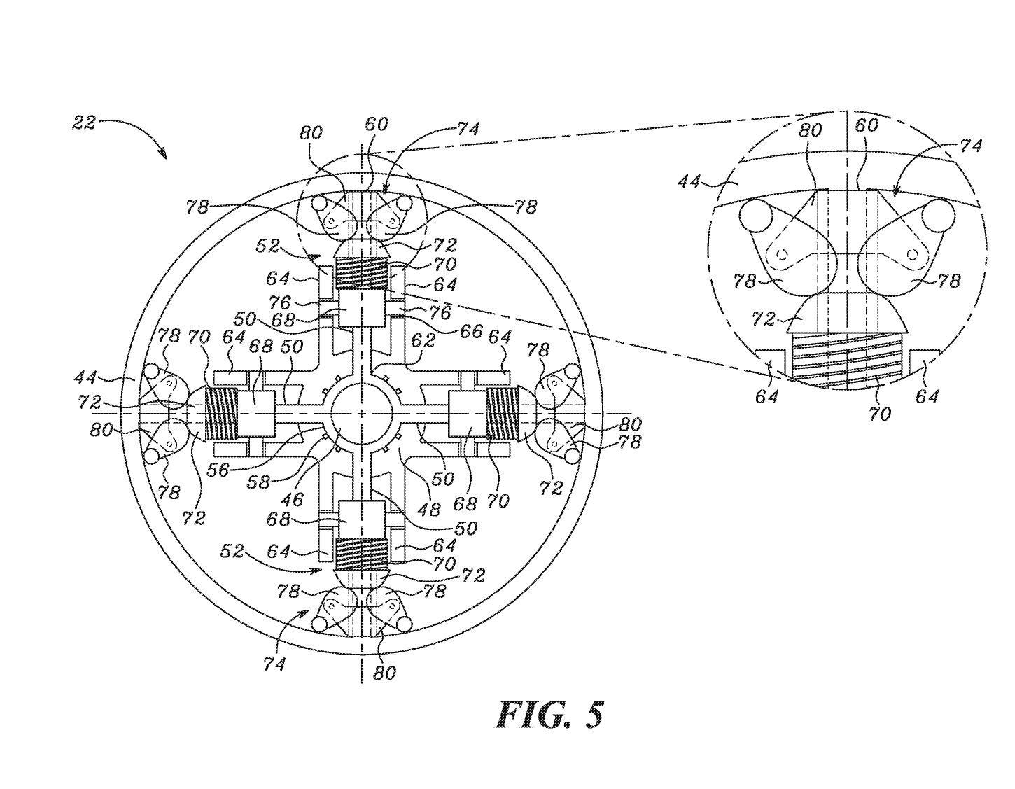

Referring to FIG. 5, when the rotational speed (i.e. angular velocity) of the flywheel 22 is above a predetermined value, two types of internal stresses are generated in the first weight 68. The internal stresses are position dependant stresses and speed dependant stresses. The internal stresses are generated along the radial direction away from the first axis 2-2′ of the rim 44. The position dependant stresses are counterbalanced by a spring force generated by the spring member 70. The spring member 70 is adapted to apply the spring force along the radial direction towards the axis 2-2′ of the rim 44 to oppose the sliding of the first weight 68.

The speed dependant stresses are counterbalanced by the support member 72 and the weight assembly 74. When the flywheel 22 rotates above a predetermined angular velocity, the second weight 78 of the weight assembly 74 also rotates about the second axis 3-3′ pushing the support member 72 along the radial direction towards the first axis 2-2′ of the rim 44. Since the support member 72 is disposed adjacent to the spring member 70, the support member 72 compresses the spring member 70 that generates the spring force to counterbalance the speed dependent stresses in the first weight 68. In effect, the speed dependent stresses are counterbalanced by the force generated by the weight assembly 74 on the spring member 70.

It should be noted that the actuator 54 may be hydraulically controlled, mechanically controlled or pneumatically controlled without departing from meaning and scope of the disclosure. It should be further noted that the flywheel 22 may include one or more spokes 50, assemblies 52 and protruding members 76 depending on the design requirements of the flywheel 22 without departing from the meaning and scope of the disclosure.

### INDUSTRIAL APPLICABILITY

The present disclosure provides the flywheel 22. The inertia of the flywheel 22 is varied by moving the first weight 68 along the length of the spoke 50. When the first weight 68 moves towards the rim 44, the inertia of the flywheel 22 increases and when the first weight 68 moves away from the rim 44, the inertia of the flywheel 22 decreases. For the flywheel 22 with a constant amount of energy, decreasing its inertia increases its speed and increasing its inertia decreases its speed. Since the flywheel 22 is adapted to change its speed by varying its inertia, the flywheel 22 is self sufficient to match its speed around that of the first gear 36, in order to transmit or receive energy to/from the powertrain 10. Thus, the flywheel 22 eliminates the use of an additional transmission assembly in order to transmit energy between the flywheel 22 and the powertrain 10.

Also, the flywheel 22 includes a mechanism to counterbalance the position dependent stresses and the speed dependent stresses generated on the first weight 68 that destabilize the first weight 68 when the flywheel 22 rotates at higher rotational speed. To counterbalance the position dependent stresses, the spring member 70 is adapted to apply a spring force to the first weight 68 along the radial direction. To counterbalance the speed dependent stresses, the second weight 78 rotates about the second axis 3-3′ pushing the support member 72 along the length of the spoke 50. The support member 72 compresses the spring member 70 that applies a spring force to the first weight 68 along the radial direction and counters the speed dependant stresses.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A flywheel comprising:
a rim having a circular shape;
a first hub disposed coaxially within the rim, and elongated along a first axis of the rim;
at least two spokes, each of the at least two spokes having a first end coupled to the rim and a second end coupled to the first hub;
a second hub disposed coaxially with the rim, and adapted to slide on an outer surface of the first hub along the first axis of the rim, the second hub having at least one guiding member, the at least one guiding member including a slot;
at least two assemblies corresponding to the at least two spokes, such that one of the at least two assemblies is coupled to one of the at least two spokes, each of the at least two assemblies including:
a first weight disposed adjacent to the first hub, and disposed coaxially with the one of the at least two spokes, the first weight adapted to slide along a length of the one of the at least two spokes, and having at least one protruding member, the at least one protruding member adapted to slide along the slot of the at least one guiding member;
a spring member disposed adjacent to the first weight along a radial direction, and the spring member disposed coaxially with the first weight, the spring member adapted to apply a spring force to the first weight to oppose the sliding of the first weight along the length of the one of the at least two spokes in the radial direction; and
a support member disposed adjacent to the spring member along the radial direction, and the support member disposed coaxially with the spring member, the support member adapted to slide along the length of the one of the at least two spokes;
a weight assembly including:
at least one second weight disposed adjacent to the support member along the radial direction, the at least one second weight having a cam shape, and adapted to rotate about a second axis of the at least one second weight, wherein the at least one second weight adapted to compress the spring member above a predetermined angular velocity of the flywheel; and
a mount member disposed coaxially with the support member, and coupled to the at least one second weight, the mount member adapted to slide along the length of the one of the at least two spokes; and
an actuator coupled to the second hub, and adapted to move the second hub along the first axis of the rim.
